(19) United States
(12) Patent Application Publication
(10) Pub. No.: US 2026/0038470 A1
(43) Pub. Date: Feb. 5, 2026

(54) METHOD, APPARATUS AND TERMINAL DEVICE FOR AUDIO PROCESSING

(71) Applicants: DOUYIN VISION CO., LTD., Shijingshan District, Beijing (CN); Beijing Zitiao Network Technology Co., Ltd., Haidian District, Beijing (CN)

(72) Inventors: Lamtharn Hantrakul, Beijing (CN); Wenhan Meng, Beijing (CN); Peidao Li, Beijing (CN); Yanbing Li, Beijing (CN); Xingyi Li, Beijing (CN)

(21) Appl. No.: 19/099,867

(22) PCT Filed: Aug. 18, 2023
(86) PCT No.: PCT/CN2023/113811

§ 371 Date: Jan. 30, 2025

(30) Foreign Application Priority Data
Oct. 20, 2022 (CN) 202211289254.0

(51) Int. Cl. G10H 1/36

(52) U.S. Cl. CPC G10H 1/361; G10H 2210/105; G10H 2220/096; G10H 2220/116

(57) ABSTRACT

The disclosure provides a method, apparatus and terminal device for audio processing, and the method includes: displaying a first page comprising a first region associated with audio editing and a second region associated with text editing; and in response to an editing operation on the first region or the second region, displaying a first accompaniment region in the first region, and displaying a first lyric region in the second region.

### CROSS REFERENCE TO RELATED APPLICATIONS

This application claims priority to Chinese Patent Application No. 202211289254.0, entitled “METHOD, APPARATUS AND TERMINAL DEVICE FOR AUDIO PROCESSING” filed on Oct. 20, 2022, the entirety of which is incorporated herein by reference.

### FIELD

Embodiments of the present disclosure relate to the field of audio processing technologies, and in particular, to a method, apparatus and terminal device for audio processing.

### BACKGROUND

Music creators may use music applications for music creation. For example, music creators may add audio effects to a segment of audio through music applications.

Currently, a music creator may add a segment of created music composition to a music application, and add phonemes such as sound effects, lyrics and the like in the music composition through a music application. However, the creation difficulty of music composition and lyrics is high, the existing audio editing function is limited, and the requirement on the music creator is high. The music creator cannot simply perform music creation, and the efficiency of music creation is low.

### SUMMARY

The present disclosure provides a method, apparatus and terminal device for audio processing, which are used for solving the technical problem of low efficiency of music creation in the prior art.

According to a first aspect, the present disclosure provides a method of audio processing, including: displaying a first page comprising a first region associated with audio editing and a second region associated with text editing; in response to an editing operation on the first region or the second region, displaying a first accompaniment region in the first region, and displaying a first lyric region in the second region.

According to a second aspect, the present disclosure provides an apparatus for audio processing, including a display module and a response module. The display module is configured to display a first page comprising a first region associated with audio editing and a second region associated with text editing. The responding module is configured to, in response to an editing operation on the first region or the second region, display a first accompaniment region in the first region and display a first lyric region in the second region.

According to a third aspect, the embodiments of the present disclosure provide a terminal device, including a processor and a memory. The memory stores computer executable instructions. The processor executes the computer executable instructions stored in the memory, so that the at least one processor performs the method of audio processing according to the first aspect and various possible methods according to the first aspect.

According to a fourth aspect, the embodiments of the present disclosure provide a computer readable storage medium storing computer executable instruction which, when a processor executes the computer executable instructions, implements the method of audio processing according to the first aspect and various possible methods according to the first aspect.

According to a fifth aspect, the embodiments of the present disclosure provide a computer program product, including a computer program which, when executed by a processor, implements the method of audio processing according to the first aspect and various possible methods according to the first aspect.

According to a sixth aspect, the embodiments of the present disclosure provide a computer program, when executed by a processor, implementing the method of audio processing according to the first aspect and various possible methods according to the first aspect.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is a schematic diagram of an application scenario according to the embodiments of the present disclosure;

FIG. 2 is a schematic flowchart of a method of audio processing according to the embodiments of the present disclosure;

FIG. 3 is a schematic diagram of a process of displaying a first page according to the embodiments of the present disclosure;

FIG. 4 is a schematic diagram of a process of displaying a first accompaniment region and a first lyric region according to the embodiments of the present disclosure;

FIG. 5 is a schematic diagram of displaying a first lyric region and a first accompaniment region according to the embodiments of the present disclosure;

FIG. 6A is a schematic diagram of deleting a first lyric region and a first accompaniment region according to the embodiments of the present disclosure;

FIG. 6B is a schematic diagram of deleting a first accompaniment region and a first lyric region according to the embodiments of the present disclosure;

FIG. 7 is a schematic diagram of displaying a first accompaniment region and a first lyric region according to the embodiments of the present disclosure;

FIG. 8 is a schematic diagram of a process of displaying an accompaniment style window according to the embodiments of the present disclosure;

FIG. 9 is a schematic diagram of a process of determining a target accompaniment style according to the embodiments of the present disclosure;

FIG. 10 is a schematic diagram of a process of displaying a first accompaniment region according to the embodiments of the present disclosure;

FIG. 11 is a schematic diagram of displaying a first lyric region and a first accompaniment region according to the embodiments of the present disclosure;

FIG. 12 is a schematic diagram of a process of displaying a text title window according to the embodiments of the present disclosure;

FIG. 13 is a schematic diagram of a process of displaying a first lyric region according to the embodiments of the present disclosure;

FIG. 14 is a schematic diagram of a process of displaying lyrics according to the embodiments of the present disclosure;

FIG. 15 is a schematic diagram of a method for displaying a first voice according to the embodiments of the present disclosure;

FIG. 16 is a schematic diagram of a process of displaying a sound effect window according to the embodiments of the present disclosure;

FIG. 17 is a schematic diagram of adding an audio track associated with a second audio track according to the embodiments of the present disclosure;

FIG. 18 is a schematic structural diagram of an apparatus for audio processing according to the embodiments of the present disclosure;

FIG. 19 is a schematic structural diagram of another apparatus for audio processing according to the embodiments of the present disclosure; and

FIG. 20 is a schematic structural diagram of a terminal device according to the embodiments of the present disclosure.

### DETAILED DESCRIPTION

Example embodiments will be described in detail here, examples of which are illustrated in the accompanying drawings. The following description relates to the accompanying drawings, in which the same numerals indicate the same or similar elements unless otherwise indicated. The implementations described in the following example embodiments do not represent all implementations consistent with the present disclosure. In contrast, they are merely examples of apparatuses and methods consistent with some aspects of the disclosure as detailed in the appended claims.

For ease of understanding, the concepts involved in the embodiments of the present disclosure are described below.

The terminal device is a device having a wireless transceiver function. The terminal device may be deployed on land, including indoor or outdoor, handheld, wearable, or vehicle-mounted; or may be deployed on a water surface (for example, a ship, etc.). The terminal device may be a mobile phone, a portable android device (PAD), a computer with a wireless transceiver function, a virtual reality (VR) terminal device, an augmented reality (AR) terminal device, a wireless terminal in industrial control, a vehicle-mounted terminal device, a wireless terminal in self-driving, a wireless terminal device in a remote medical, a wireless terminal device in a smart grid, a wireless terminal device in transportation safety, a wireless terminal device in a smart city, a wireless terminal device in a smart home, a wearable terminal device, or the like. The terminal device in the embodiments of the present disclosure may also be referred to as a terminal, user equipment (UE), an access terminal device, a vehicle-mounted terminal, an industrial control terminal, a UE unit, a UE station, a mobile station, a moving station, a remote station, a remote terminal device, a mobile device, a UE terminal device, a wireless communication device, a UE agent, or a UE device. The terminal device may also be fixed or mobile.

Music theory: music theory is a basic theory of music theory, including a basic theory with low difficulty. For example, the music theory may include content such as music reading, pitch, chord, rhythm, beat, and the like. The music theory may also include a more difficult theory. For example, music theory may include content such as harmony, polyphony, musical form, melody, orchestration, and the like.

Music composition: music composition is a process of combining music theory to compose music. For example, the composition may write an accompaniment and harmony process for the musical work according to the main melody (beat) of the music and the style of the work that the creator wishes to perform (cheerful, rock, etc.).

In the related art, a music creator may create a segment of accompaniment and add phonemes such as sound effect and lyrics to the accompaniment through a music application, thereby completing the creation of music. However, the creation difficulty of accompaniment and lyrics is high, the music creator needs to learn the music theory knowledge, the existing music editing function is limited, and the operation complexity is high. The music creator cannot simply perform music creation, and the efficiency of music creation is low.

In order to solve the technical problem in the related art, the embodiments of the present disclosure provide a method of audio processing, the terminal device may display a first region associated with audio editing and a second region associated with text editing; in response to a trigger operation on the first region, display a first accompaniment region in the first region, and display a first lyric region corresponding to the first accompaniment region in the second region, or in response to a trigger operation on the second region, display a first lyric region in the second region, and display a first accompaniment region corresponding to the first lyric region in the first region. In the foregoing method, if the music creator performs the text editing operation on the second region for text editing, the terminal device may display the accompaniment region associated with the text editing operation in the first region. If the music creator performs an audio editing operation on the first region for audio editing, the terminal device may display the lyric region associated with the audio editing operation in the second region. In this way, when the user performs the editing operation in any region, the terminal device may generate and display the accompaniment region and the lyric region, thereby reducing the complexity of music creation and improving the efficiency of music creation.

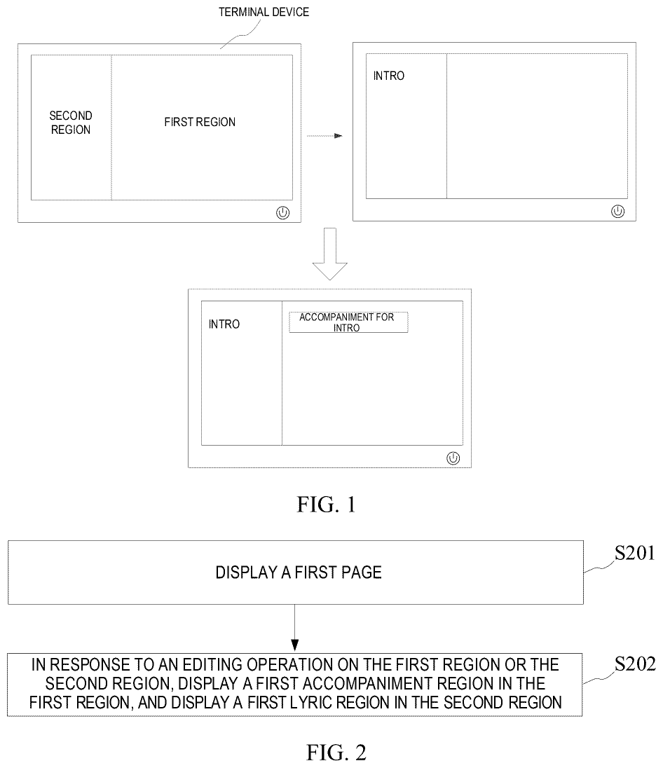

An application scenario of the embodiments of the present disclosure will be described below with reference to FIG. 1.

FIG. 1 is a schematic diagram of an application scenario according to the embodiments of the present disclosure. Referring to FIG. 1, a terminal device is included. The display page of the terminal device is a first page, and the first page includes a first region associated with audio editing and a second region associated with text editing. If the terminal device displays the text “intro” in the second region, the terminal device may display an accompaniment corresponding to the intro in the first region. In this way, when the user performs the editing operation in any region, the terminal device may display the corresponding content in another region, reducing the complexity of music creation and further improving the efficiency of music creation.

It should be noted that FIG. 1 is merely an example application scenario of the embodiments of the present disclosure, and is not a limitation on the application scenario of the embodiments of the present disclosure.

Technical solutions of the present disclosure and how the technical solutions of the present disclosure solve the aforementioned technical problems are described in detail below with reference to specific embodiments. The following several specific embodiments may be combined with each other, and the same or similar concepts or processes may not be repeated in some embodiments. The embodiments of the present disclosure will be described below with reference to the accompanying drawings.

FIG. 2 is a schematic flowchart of a method of audio processing according to the embodiments of the present disclosure. Referring to FIG. 2, the method may include the following steps.

At step S201, a first page is displayed.

The executing body of the embodiments of the present disclosure may be a terminal device or an apparatus for audio processing disposed in the terminal device. The apparatus for audio processing may be implemented by software, and the apparatus for audio processing may also be implemented by combining software and hardware.

Optionally, the first page includes a first region and a second region. Optionally, the first region is associated with audio editing, and the second region is associated with text editing. Optionally, an audio may be displayed in the first region. For example, the terminal device may display a Spectrum diagram corresponding to the accompaniment in the first region, and the terminal device may also display the frequency corresponding to the accompaniment in the first region.

Optionally, a text may be displayed in the second region. For example, the terminal device may display a title (e.g., an intro, a verse, etc.) in the second region, the terminal device may display the lyrics in the second region, the terminal device may also display the title and the lyrics in the second region, which is not limited in the embodiments of the present disclosure.

Optionally, the terminal device may display the first page in a feasible implementation manner as follows: in response to a touch operation on a browser program, displaying a browser page, inputting the first website associated with the first page in the website input region of the browser page, and displaying the first page in response to a jump operation on the first website. For example, if the user clicks a browser application in the terminal device, the terminal device may display a page corresponding to the browser, the browser page includes a website input region, the user may input a website associated with the first page in the website input region, and click a page jump control, the browser may jump to the first page, and display the first page.

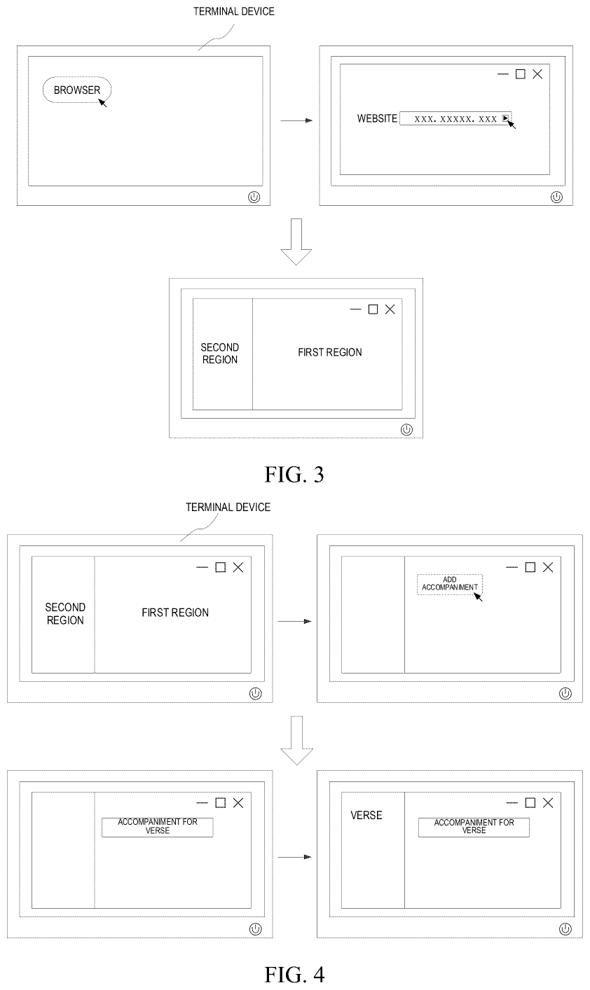

The process of displaying the first page is described below with reference to FIG. 3.

FIG. 3 is a schematic diagram of a process of displaying the first page according to the embodiments of the present disclosure. Referring to FIG. 3, a terminal device is included. The display page of the terminal device includes a browser control. If the user clicks the browser control through a mouse, the terminal device displays a browser page, and the browser page includes a website input region. If the user inputs the website associated with the first page and clicks the jump control, the browser page may jump to the first page, where the first page includes the first region and the second region.

It should be noted that, in the embodiment shown in FIG. 3, the user may click the display page of the terminal device through a mouse or may click the display page in a touch manner, or may perform a trigger operation on the display page through voice control, which is not limited in the embodiments of the present disclosure.

At S202: in response to an editing operation on the first region or the second region, display a first accompaniment region in the first region, and display a first lyric region in the second region.

Optionally, in response to the editing operation on the first region or the second region, the first accompaniment region is displayed in the first region, the first lyric region is displayed in the second region, and there are the following two cases.

Case 1: In response to a trigger operation on the first region.

Optionally, in response to the trigger operation on the first region, the first accompaniment region is displayed in the first region, and the first lyric region corresponding to the first accompaniment region is displayed in the second region. Optionally, the first lyric region may include a lyrics paragraph title and text content. For example, the lyrics paragraph title may be a title of the music composition paragraph, and the text content may be lyrics of the music composition. For example, the lyrics paragraph title may be a title such as “intro”, “verse”, “chorus” or “outro”, and the text content may be text lyrics input by the user or lyrics recommended by the terminal device intelligently.

Optionally, the trigger operation on the first region may include a touch operation or a voice operation performed by the user on the first region, which is not limited in the embodiments of the present disclosure. For example, when the user performs a click operation on the first region, the terminal device may display the first accompaniment region in the first region, and display the first lyric region corresponding to the first accompaniment region in the second region.

Optionally, the first accompaniment region in the first region may include accompaniment. For example, if the user performs a click operation in the first region, the first region may display the first accompaniment region, and the first accompaniment region may include a note graph of the accompaniment (notes that displays the accompaniment), a spectrum diagram (display the amplitude of the accompaniment), and the like, which is not limited in the embodiments of the present disclosure.

Optionally, the terminal device may intelligently recommend an accompaniment associated with the first accompaniment region, and the terminal device may also load an external accompaniment, which is not limited in the embodiments of the present disclosure. It should be noted that each first accompaniment region has a corresponding first lyric region. For example, if the first accompaniment region is an intro region in the music composition, the lyrics paragraph title of the first lyrics corresponding to the first accompaniment region is a text “intro”, and the text content in the first lyric region is the lyrics of the intro.

The process of displaying the first accompaniment region and the first lyric region in this case will be described below with reference to FIG. 4.

FIG. 4 is a schematic diagram of a process of displaying a first accompaniment region and a first lyric region according to the embodiments of the present disclosure. Referring to FIG. 4, a terminal device is included. The display page of the terminal device includes a first page, the first page includes a second region and a first region, and the first region includes an accompaniment addition control. If the user clicks to the accompaniment addition control through the mouse, the terminal device may generate the accompaniment region of the verse in the first region, the accompaniment region includes the accompaniment for the verse, and the lyrics paragraph title “verse” is displayed in the second region, so that the operation complexity of music creation can be reduced, and the audio creating efficiency is improved.

In this case, if the user clicks on the first region, the terminal device may intelligently recommend the accompaniment associated with the first accompaniment region, display the note graph of the accompaniment in the first accompaniment region, and display the first lyric region corresponding to the first accompaniment region in the second region, which may reduce the complexity of music creation and improve the efficiency of music creation.

Case 2: In response to a trigger operation on the second region.

Optionally, in response to a trigger operation on the second region, the first lyric region is displayed in the second region, and the first accompaniment region corresponding to the first lyric region is displayed in the first region. For example, if the user performs a click operation on the second region, the terminal device may display the first lyric region in the second region and display the first accompaniment region corresponding to the first lyric region in the first region. For example, if the terminal device displays a region for intro lyrics in the second region, the terminal device displays the intro accompaniment region corresponding to the intro lyric region in the first region.

Optionally, the trigger operation on the second region may include a touch operation or a voice operation performed by the user on the second region, which is not limited in the embodiments of the present disclosure.

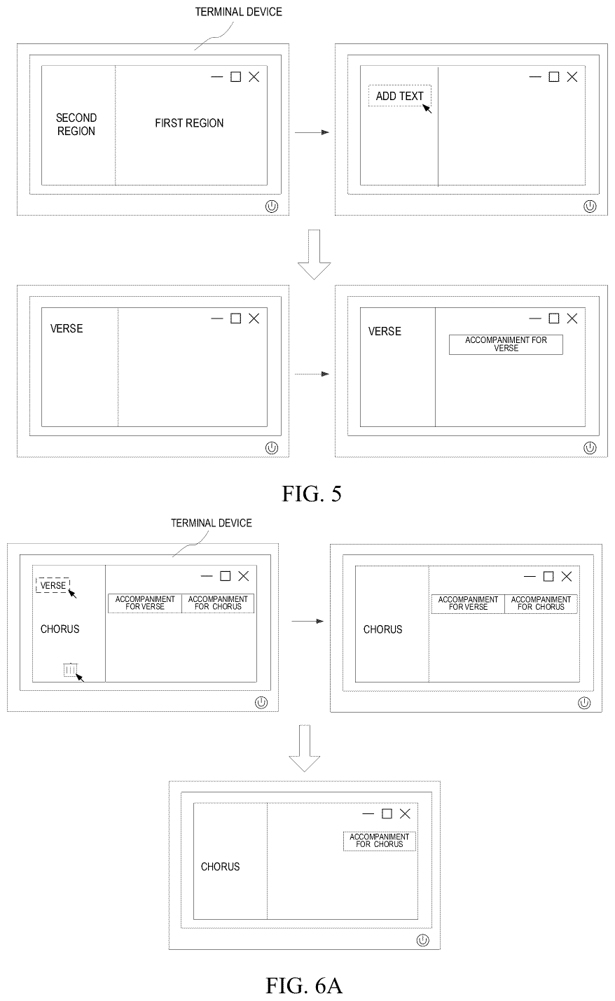

In the following, with reference to FIG. 5, in this case, the process of displaying the first lyric region in the second region, and displaying the first accompaniment region corresponding to the first lyric region in the first region is described.

FIG. 5 is a schematic diagram of displaying a first lyric region and a first accompaniment region according to the embodiments of the present disclosure. Referring to FIG. 5, a terminal device is included. The display page of the terminal device includes a first page, the first page includes a first region and a second region, and the second region includes a text addition control. If the user clicks to the text addition control through the mouse, the terminal device may generate the lyrics paragraph title “verse” in the second region, and display the accompaniment region of the verse in the first region, where the accompaniment region includes the accompaniment for the verse, so that the operation complexity of music creation can be reduced, and the audio creating efficiency is improved.

In this case, if the user clicks the second region, the terminal device may display the first lyric region in the second region and may display the first accompaniment region corresponding to the first lyric region in the first region. In this way, the operation complexity of music creation can be reduced, and the audio creating efficiency is improved.

Optionally, after the terminal device displays the first accompaniment region in the first region and displays the first lyric region in the second region, the method of audio processing further includes a deletion operation on the first accompaniment region or the first lyric region. Optionally, the terminal device may delete the first accompaniment region or the first lyric region based on a feasible implementation manner: in response to a deletion operation on the first accompaniment region, cancelling the display of the first lyric region associated with the first accompaniment region in the second region, or in response to a deletion operation on the first lyric region, cancelling the display of the first accompaniment region corresponding to the first lyric region in the first region.

Optionally, if the terminal device deletes the first accompaniment region in the first region, the terminal device cancels, in the second region, the display of the first lyric region corresponding to the first accompaniment lyric region. For example, the intro accompaniment region in the first region is associated with the intro lyric region in the second region, and the verse accompaniment region in the first region is associated with the lyric region of the verse in the second region. If the user deletes the intro accompaniment region in the first region, the terminal device cancels the display of the intro lyric region in the second region, and if the user deletes the verse accompaniment region in the first region, the terminal device cancels the display of the verse lyric region in the second region.

Optionally, if the terminal device deletes the first lyric region in the second region, the terminal device cancels, in the first region, the display of the first accompaniment region corresponding to the first lyric region. For example, the intro lyric region in the second region is associated with the intro accompaniment region in the first region, the outro lyric region in the second region is associated with the outro accompaniment region in the first region, and if the user deletes the intro lyric region in the second region, the terminal device cancels the display of the intro accompaniment region in the first region, and if the user deletes the outro lyric region in the second region, the terminal device cancels the display of the outro accompaniment region in the first region.

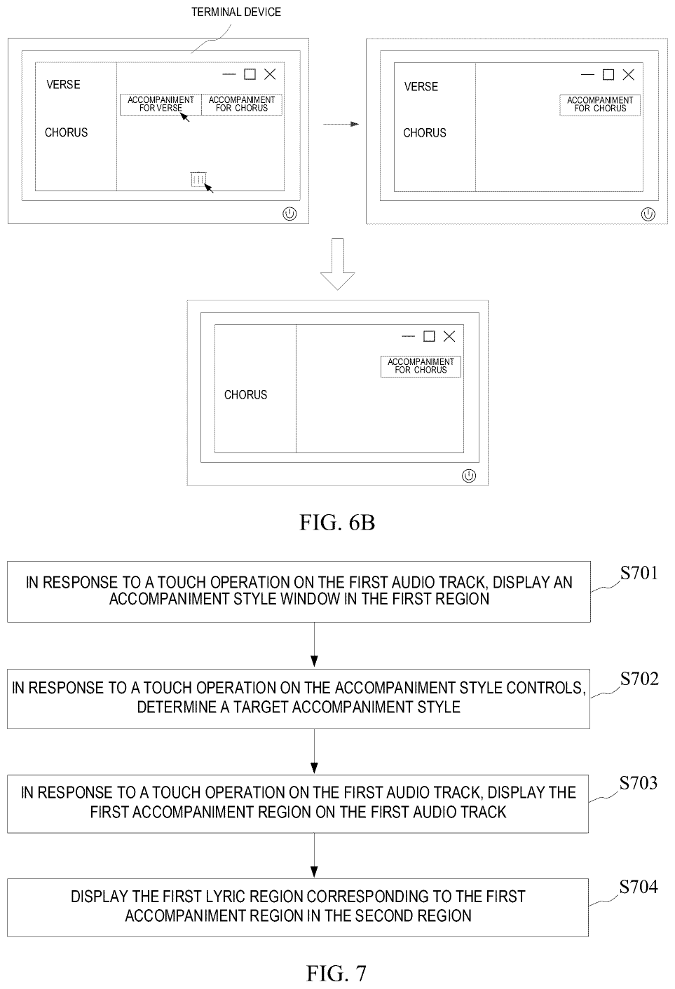

The process of deleting the first lyric region and the first accompaniment region is described below with reference to FIGS. 6A-6B.

FIG. 6A is a schematic diagram of deleting a first lyric region and a first accompaniment region according to the embodiments of the present disclosure. Referring to FIG. 6A, a terminal device is included. The display page of the terminal device includes a first page, and the first page includes a first region and a second region. The first region includes the accompaniment region of the verse and the accompaniment region of the chorus, the accompaniment region of the verse includes the accompaniment for the verse, the accompaniment region of the chorus includes the accompaniment of the chorus, the second region includes the lyric region of the verse and the lyric region of the chorus, the lyric region of the verse includes the text “verse”, and the lyric region of the chorus includes the text “chorus”.

Referring to FIG. 6A, if the user clicks the lyric region of the verse through the mouse and clicks the deletion control to delete the lyric region of the verse, the second region of the first page cancels the display of the text “verse”, and the display of the accompaniment region of the verse is canceled in the first region of the first page. In this way, the operation complexity of music creation is reduced, and the efficiency of music creation is improved.

FIG. 6B is a schematic diagram of deleting a first accompaniment region and a first lyric region according to the embodiments of the present disclosure. Referring to FIG. 6B, a terminal device is included. The display page of the terminal device includes a first page, and the first page includes a first region and a second region. The first region includes the accompaniment region of the verse and the accompaniment region of the chorus, the accompaniment region of the verse includes the accompaniment for the verse, the accompaniment region of the chorus includes the accompaniment of the chorus, the second region includes the lyric region of the verse and the lyric region of the chorus, the lyric region of the verse includes the text “verse”, and the lyric region of the chorus includes the text “chorus”.

Referring to FIG. 6B, if the user clicks the accompaniment region of the verse through the mouse and clicks the deletion control to delete the accompaniment region of the verse, the display of the accompaniment region of the verse is canceled in the first region of the first page, and the display of the text “verse” associated with the accompaniment region of the verse is canceled in the second region of the first page. In this way, the operation complexity of music creation is reduced, and the efficiency of music creation is improved.

The embodiments of the present disclosure provide a method of audio processing including: at a terminal device, displaying a first page including a first region and a second region; in response to a trigger operation on the first region, displaying a first accompaniment region in the first region and displaying a first lyric region corresponding to the first accompaniment region in the second region, or in response to a trigger operation on the second region, displaying the first lyric region in the second region, and displaying the first accompaniment region corresponding to the first lyric region in the first region. In this way, if the user performs the editing operation in any region, the terminal device may display the content associated with the editing operation in another region, thereby reducing the complexity of music creation and improving the efficiency of music creation.

Based on the embodiment shown in FIG. 2, with reference to FIG. 7, in the foregoing method of audio processing, the method for displaying the first accompaniment region in the first region in response to a trigger operation on the first region and displaying the first lyric region corresponding to the first accompaniment region in the second region is described in detail.

FIG. 7 is a schematic diagram of displaying a first accompaniment region and a first lyric region according to the embodiments of the present disclosure. In the embodiment shown in FIG. 7, the first region includes a first audio track. With reference to FIG. 7, the method includes the following steps.

At S701: in response to a touch operation on the first audio track, display an accompaniment style window in the first region.

Optionally, the first region may include a first audio track. For example, the first region may include a first audio track associated with the beat of music composition. Optionally, the accompaniment style window includes a plurality of accompaniment style controls. For example, the accompaniment style window includes an accompaniment style control A and an accompaniment style control B, and each accompaniment style control may be associated with one accompaniment style. For example, the accompaniment style window may include a “popular” control, a “electric music” control, and a “rock” control, where the accompaniment style corresponding to the “popular” control is the popular style, the accompaniment style corresponding to the “electric music” control is the electric music style, and the accompaniment style corresponding to the “rock” control is the rock style.

Optionally, if the user clicks the first audio track, the accompaniment style window including the plurality of accompaniment style controls may be popped up in the first region in the first page. It should be noted that the accompaniment style window may be in the first region or other region in the first page, which is not limited in the embodiments of the present disclosure.

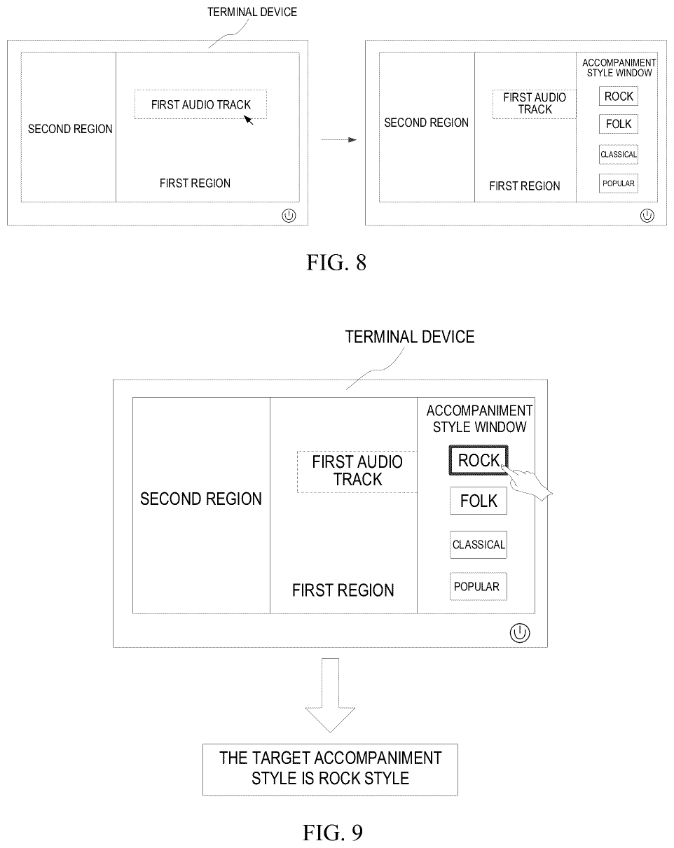

The process of displaying the accompaniment style window is described below with reference to FIG. 8.

FIG. 8 is a schematic diagram of a process of displaying an accompaniment style window according to the embodiments of the present disclosure. Referring to FIG. 8, a terminal device is included. The display page of the terminal device includes a first page, the first page includes a first region and a second region, and the first region includes the first audio track. If the user clicks the first audio track through the mouse, the accompaniment style window pops up on the right side of the first region, where the accompaniment style window includes a rock control, a folk control, a classical control, and a popular control.

At S702: in response to a touch operation on the accompaniment style controls, determine a target accompaniment style.

Optionally, the target accompaniment style is a style of accompaniment associated with the first accompaniment region. For example, the accompaniment style window includes a control of accompaniment style A and a control of accompaniment style B. If the user clicks the control of accompaniment style A, the terminal device determines that the target accompaniment style is the accompaniment style A, the style of the accompaniment associated with the first accompaniment region is the accompaniment style A. If the user clicks the control of accompaniment style B, the terminal device determines that the target accompaniment style is the accompaniment style B, and the style of the accompaniment associated with the first accompaniment region is the accompaniment style B.

Optionally, the terminal device may intelligently generate an accompaniment associated with the first accompaniment region based on the target accompaniment style. For example, if the user clicks the rock style control in the accompaniment style window, the style of the accompaniment associated with the first accompaniment region generated by the terminal device is the rock style. If the user clicks the electric music style control, the style of the accompaniment associated with the first accompaniment region generated by the terminal device is the first accompaniment of the electric music style.

The process of determining the target accompaniment style is described below with reference to FIG. 9.

FIG. 9 is a schematic diagram of a process of determining a target accompaniment style according to the embodiments of the present disclosure. Referring to FIG. 9, a terminal device is included. The display page of the terminal device includes a first page, and the first page includes a first region and a second region. The first region includes a first audio track, and a right side of the first region pops up an accompaniment style window. The accompaniment style window includes a rock control, a folk control, a classical control, and a popular control. If the user clicks the rock control, the terminal device may determine that the target accompaniment style is the rock style.

At S703: in response to a touch operation on the first audio track, display the first accompaniment region on the first audio track.

Optionally, the first accompaniment region includes an accompaniment of the target accompaniment style. For example, after the terminal device determines the target accompaniment style, in response to a touch operation on the first audio track, the terminal device may display, on the first audio track, a note graph of accompaniment associated with the first accompaniment region, where the accompaniment style indicated by the note graph is the target accompaniment style.

Optionally, in response to a touch operation on the first audio track, the terminal device may display the first accompaniment region on the first audio track based on a feasible implementation manner: in response to a touch operation on the first audio track, displaying an accompaniment addition window. Optionally, the accompaniment addition window includes an accompaniment paragraph control, and an accompaniment paragraph is a position of a segment of accompaniment in a whole accompaniment. For example, the accompaniment paragraph may include paragraphs, such as an intro, a verse, a chorus, and an outro. The accompaniment addition window may include an intro control, a verse control, a chorus control, an outro control, and the like. For example, if the user clicks on the first audio track, the terminal device may display the accompaniment addition window.

Optionally, the first accompaniment region is displayed on the first audio track in response to a touch operation on the accompaniment paragraph control. Optionally, the accompaniment paragraph associated with the first accompaniment region is the same as the accompaniment paragraph corresponding to the accompaniment paragraph control. For example, the accompaniment paragraph window includes an intro control and a verse control. If the user clicks the intro control, the first accompaniment region generated by the terminal device is an accompaniment region of the intro, and the accompaniment is displayed in the accompaniment region of the intro. If the user clicks the verse control, the first accompaniment region generated by the terminal device is the accompaniment region of the verse, and the accompaniment for the verse is displayed in the accompaniment region of the verse. For example, if the target accompaniment style is rock, if the user clicks the verse control, the terminal device may display the accompaniment region of the verse on the first audio track of the first region, the accompaniment region of the verse includes the accompaniment for the verse. If the user clicks the chorus control, the terminal device may display the accompaniment region of the chorus on the first audio track of the first region, and the accompaniment region of the chorus includes the accompaniment of the chorus.

Optionally, the first accompaniment region further includes an accompaniment display control, and the accompaniment display region includes an amplitude waveform corresponding to the accompaniment associated with the first accompaniment region. For example, the first accompaniment region displays the accompaniment associated with the first accompaniment region through the accompaniment display region. For example, the accompaniment display region may include a note graph, a spectrum diagram, and the like corresponding to the accompaniment associated with the first accompaniment region. Optionally, sizes of the accompaniment display region and the first accompaniment region may be the same or different, which is not limited in the embodiments of the present disclosure.

The size of the accompaniment display region is adjusted and the amplitude waveform is adjusted in response to a touch operation on the accompaniment display region. For example, the terminal device may adjust the size of the accompaniment display region in response to a sliding operation on the edge of the accompaniment display region. It should be noted that when adjusting the size of the accompaniment display region, the amplitude waveform in the accompaniment display control is changed as well.

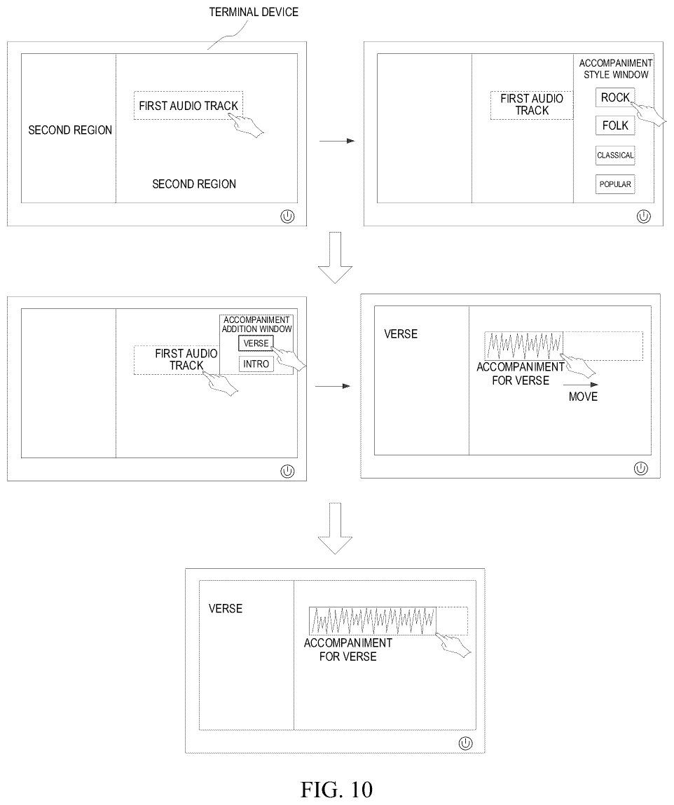

The process of displaying the first accompaniment region is described below with reference to FIG. 10.

FIG. 10 is a schematic diagram of a process of displaying a first accompaniment region according to the embodiments of the present disclosure. Referring to FIG. 10, a terminal device is included. The display page of the terminal device includes a first page, the first page includes a first region and a second region, and the first region includes a first audio track. If the user clicks on the first audio track, the right side of the first region pops up the accompaniment style window, and the accompaniment style window includes a rock control, a folk control, a classical control, and a popular control.

Referring to FIG. 10, if the user clicks the rock control, the terminal device determines that the target style control is a rock style. If the user clicks the first audio track in the first region again, the first region may pop up the accompaniment addition window, where the accompaniment addition window includes a verse control and an intro control. If the user clicks the verse control, the terminal device may display an accompaniment region of the verse in the first region, the accompaniment region of the verse includes an audio display region corresponding to the accompaniment for the verse, and the audio display region includes the amplitude waveform of the accompaniment for the verse with the rock style.

Referring to FIG. 10, if the user moves the audio display region corresponding to the accompaniment for the verse to the right, the length of the audio display region corresponding to the verse accompaniment on the first audio track increases (that is, the accompaniment for the verse takes up more time in the music creation, the first audio track corresponds to the play progress, and the accompaniment region of the verse also grows), and since the accompaniment for the verse is a whole, if the verse grows, the whole accompaniment will change, and therefore, the amplitude waveform in the audio display region also changes. In this way, flexibility of audio creation and efficiency of audio creation can be improved.

It should be noted that only the accompaniment region of the verse is shown on the first audio track in FIG. 10. If the first audio track further includes the audio display region of the chorus accompaniment and the audio display region of the intro accompaniment, and if the size of any one of the audio display regions is adjusted, the amplitude waveform in each audio display region may change.

At S704: display the first lyric region corresponding to the first accompaniment region in the second region.

Optionally, after the terminal device displays the first accompaniment region in the first region, the terminal device may display the first lyric region corresponding to the first accompaniment region in the second region. For example, if the terminal device displays the accompaniment region of the song in the first region, the terminal device may display the lyric region of the song in the second region; and if the terminal device displays the accompaniment region of the song in the first region, the terminal device may display the lyric region of the song in the second region.

The embodiments of the present disclosure provide a method for displaying a first accompaniment region and a first lyric region, and the method includes: displaying an accompaniment style window in a first region in response to a touch operation on the first audio track, determining a target accompaniment style in response to a touch operation on an accompaniment style control in the accompaniment style window, displaying a first accompaniment region on the audio track and displaying a first lyric region corresponding to the first accompaniment region in the second region in response to a touch operation on the first audio track. In this way, the terminal device may display the first accompaniment region and generate an accompaniment associated with the first accompaniment region, and after the user adds the first accompaniment region in the first region, the terminal device may display the first lyric region corresponding to the first accompaniment region in the second region, thereby reducing the complexity of music creation and improving the efficiency of music creation.

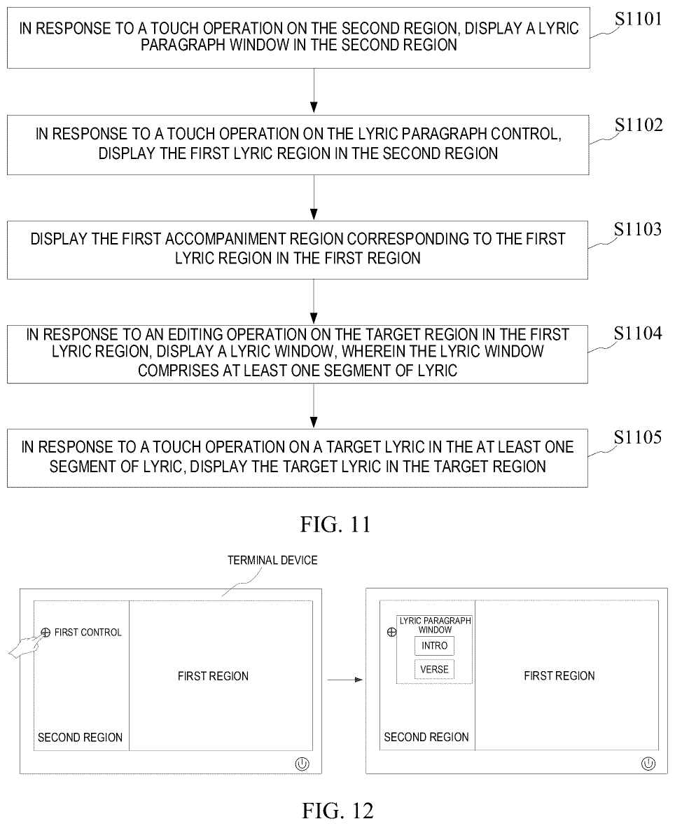

Based on any one of the foregoing embodiments, with reference to FIG. 11, in the foregoing method of audio processing, the method for displaying the first lyric region in the second region and displaying the first accompaniment region corresponding to the first lyrics in the first region in response to a trigger operation on the second region is described in detail.

FIG. 11 is a schematic diagram of displaying a first lyric region and a first accompaniment region according to the embodiments of the present disclosure. In the embodiment shown in FIG. 11, the first lyric region includes a lyrics paragraph title and lyrics. With reference to FIG. 11, the method includes the following steps.

At S1101: in response to a touch operation on the second region, display a lyric paragraph window in the second region.

Optionally, the second region may include a first control, and if the user clicks the first control, the second region may display a lyrics paragraph window. Optionally, the user may input the voice information generated by the lyrics paragraph to the terminal device (for example, the voice information of the intro title generated), and the terminal device generates the corresponding lyrics paragraph title in the second region according to the voice information.

Optionally, the lyrics paragraph window includes a lyrics paragraph control. For example, the lyrics paragraph window includes a lyrics paragraph control A and a lyrics paragraph control B, and each lyrics paragraph control may be associated with a title of a lyrics paragraph. For example, the lyrics paragraph window may include an “intro” control, a “verse” control, and a “chorus” control, where the lyrics paragraph title associated with the “intro” control is the intro, the lyric paragraph title associated with the “verse” control is the verse, and the lyrics paragraph title associated with the “chorus” control is the chorus.

The process of displaying the lyrics paragraph window is described below with reference to FIG. 12.

FIG. 12 is a schematic diagram of a process of displaying a text title window according to the embodiments of the present disclosure. Referring to FIG. 12, a terminal device is included. The display page of the terminal device includes a first page, and the first page includes a first region and a second region. The second region includes a first control. If the user clicks on the first control, the second region displays a lyrics paragraph window, where the lyrics paragraph window includes a control of intro paragraph and a control of verse paragraph.

It should be noted that, a plurality of first controls may be included in the second region, which is not limited in the embodiments of the present disclosure. If the terminal device displays the second region, the terminal device may also display a plurality of lyrics paragraph titles (for example, an intro, a verse, a chorus, an outro, and the like) in the second region according to the music theory, which facilitates the user to perform music creation and improve the efficiency of music creation.

At S1102: in response to a touch operation on the lyric paragraph control, display the first lyric region in the second region.

Optionally, the first lyric region includes a lyrics paragraph title associated with the lyrics paragraph control. For example, if the user clicks a control of a verse paragraph, the first lyric region includes a title of the verse, and if the user clicks a control of an intro paragraph, the first lyric region includes the title of the intro.

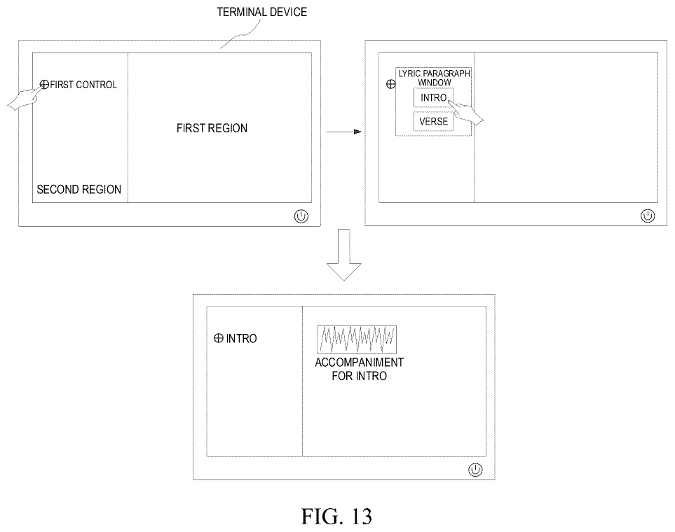

The process of displaying the first lyric region is described below with reference to FIG. 13.

FIG. 13 is a schematic diagram of a process of displaying a first lyric region according to the embodiments of the present disclosure. Referring to FIG. 13, a terminal device is included. The display page of the terminal device includes a first page, and the first page includes a first region and a second region. The second region includes a first control. If the user clicks on the first control, the second region displays a lyrics paragraph window, where the lyrics paragraph window includes a control of an intro paragraph and a control of a verse paragraph. If the user clicks the control of the intro paragraph, the terminal device determines that the lyrics paragraph is the intro paragraph, the terminal device cancels the display of the lyrics paragraph window, displays the lyrics paragraph title “intro” at the first control, displays an accompaniment region of the intro in the first region. The accompaniment region of the intro includes the accompaniment of the intro.

At S1103: display the first accompaniment region corresponding to the first lyric region in the first region.

Optionally, after the terminal device displays the first lyric region in the second region, the terminal device may display, in the first region, the first accompaniment region corresponding to the first lyric region. For example, if the first lyric region displayed by the terminal device in the second region is the lyric region of the intro, the terminal device may display the accompaniment region of the intro in the first region; and if the first lyric region displayed by the terminal device in the second region is the lyric region of the verse, the terminal device may display the accompaniment region of the verse in the first region.

It should be noted that, if the terminal device displays the first accompaniment region corresponding to the first lyric region, if the terminal device has determined the target accompaniment style selected by the user, the terminal device may enable the accompaniment style accompaniment to display in the first accompaniment region displayed in the first region. If the terminal device does not determine the target accompaniment style, the terminal device may display the accompaniment style window. If the user determines the target accompaniment style, the method for displaying the accompaniment with target accompaniment style in the first accompaniment region, determining the target accompaniment style by the terminal device may refer to the embodiment shown in FIG. 7, and details are not described here again in the embodiments of the present disclosure.

At S1104: in response to an editing operation on the target region in the first lyric region, display a lyric window, wherein the lyric window includes at least one segment of lyric.

Optionally, the first lyric region further includes a target region associated with the lyrics paragraph title. For example, the target region may be on the lower side of the lyrics paragraph title, the target region may also be on the right side of the lyrics paragraph title, which is not limited in the embodiments of the present disclosure.

Optionally, the editing operation may be a touch operation, a voice operation, or a text input operation, which is not limited in the embodiments of the present disclosure. For example, the editing operation may be that the user inputs text “rain” in the target region, and the editing operation may also be a touch operation, and a voice operation performed by the user on the target region (for example, the touch operation is a long-press operation, and the voice operation is to input voice “rain”).

Optionally, the lyrics window includes at least one segment of lyrics. Optionally, the at least one segment of lyrics is associated with an editing operation. For example, if the editing operation is to input a text “rain”, the lyrics displayed in the lyrics window are “rain”. For example, if the editing operation is to input the text “rain”, the terminal device may generate lyrics associated with the rain and display the lyrics in the lyrics window, so that the terminal device may intelligently generate lyrics and reduce the complexity of music creation.

At S1105, in response to a touch operation on a target lyric in the at least one segment of lyric, display the target lyric in the target region.

Optionally, after displaying the lyrics window in the second region, the terminal device displays the target lyrics in the target region in response to a touch operation performed by the user on the target lyrics in the at least one segment of lyrics. For example, the lyrics window includes lyrics A and lyrics B, if the user clicks the lyrics A, the terminal device displays the lyrics A in the target region, and if the user clicks the lyrics B, the terminal device displays the lyrics B in the target region.

It should be noted that, after the terminal device displays lyrics in the target region, in response to a modification operation on the lyrics, lyrics displayed in the target region may be modified. For example, the lyrics displayed in the target region are “hello”, and the user can modify the lyrics “hello” to the lyrics “bye” through the modification operation, so that if music creation is performed, the user can flexibly modify the intelligent lyrics recommended by the terminal device, thereby improving the flexibility of music creation.

It should be noted that the terminal device may display at least one segment of lyrics associated with the editing operation in the target region, and the user may directly input related lyrics to the target region through the terminal device, which is not limited in the embodiments of the present disclosure. In this way, if the creation capability of the music creator is low, the terminal device can generate lyrics associated with the editing operation, and if the creation capability of the music creator is high, the lyrics created by the music creator can be directly input to the target region, so that the user can create music intelligently and personalized, reducing the complexity of music creation and improving the efficiency of music creation.

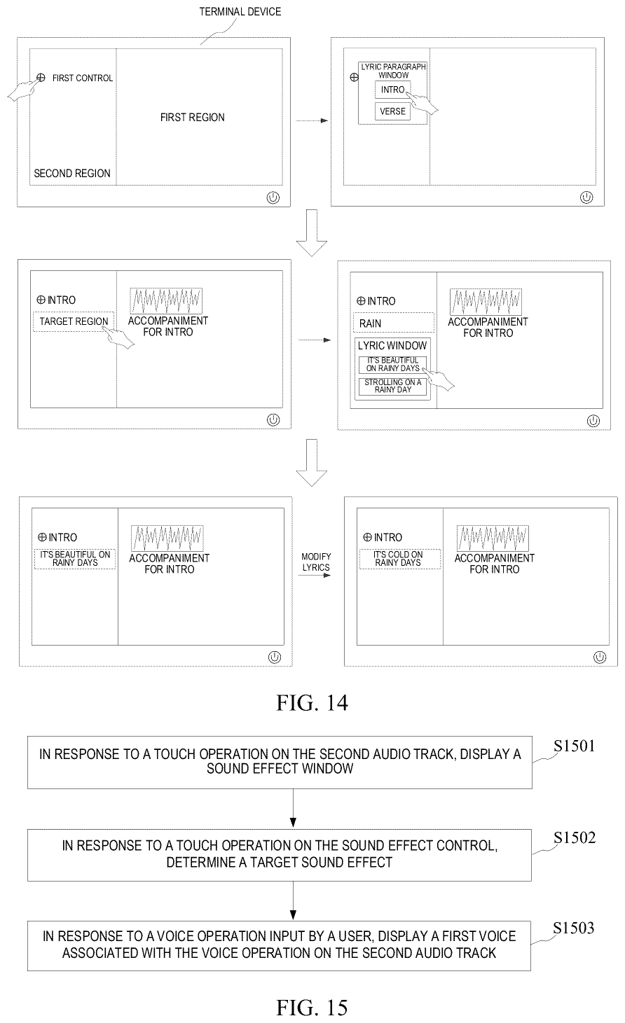

The process of displaying lyrics according to the embodiments of the present disclosure will be described below with reference to FIG. 14.

FIG. 14 is a schematic diagram of a process of displaying lyrics according to the embodiments of the present disclosure. Referring to FIG. 14, a terminal device is included. The display page of the terminal device includes a first page, and the first page includes a first region and a second region. The second region includes a first control. If the user clicks on the first control, the second region displays a lyrics paragraph window, where a text title window includes a control of an intro paragraph and a control of a verse paragraph. If the user clicks the control of the intro paragraph, the terminal device determines that the lyrics paragraph title is the intro, the terminal device cancels the display of the lyrics paragraph window, displays the lyrics paragraph title “intro” at the first control, and displays an accompaniment region of the intro in the first region. The accompaniment region of the intro includes the accompaniment for the intro.

Referring to FIG. 14, if the user clicks the target region under the title “intro” of the lyrics paragraph and inputs the text “rain” in the target region, the terminal device may display a lyrics window in the second region, where the lyrics window includes lyrics “it's beautiful on rainy days” and lyrics “strolling on a rainy day” (lyrics are associated with the input text “rain”). If the user clicks the lyrics “it's beautiful on rainy days”, the terminal device cancels the display of the lyrics window and displays the lyrics “it's beautiful on rainy days” in the target region. The segment of lyrics is the lyrics of the intro. If the user performs a touch operation on the lyrics “it's beautiful on rainy days”, the user may modify the segment of lyrics into the lyrics “it's cold on rainy days”, and the target region displays lyrics “it's cold on rainy days”. In this way, if the user inputs the key content of the lyrics, the terminal device may recommend lyrics suitable for the accompaniment style to the user based on the key content, thereby reducing the complexity of music creation and improving the efficiency of music creation.

The embodiments of the present disclosure provide a method for displaying a first lyric region and a first accompaniment region, and the method includes: displaying a lyrics paragraph window in a second region in response to a touch operation on the second region, displaying a first lyric region in the second region and displaying a first accompaniment region corresponding to the first lyric region in the first region in response to a touch operation on a lyrics paragraph control in the lyrics paragraph window, displaying a lyrics window in response to an editing operation on the target region in the first lyric region, and displaying the target lyrics in the target region in response to a touch operation on a target lyrics in the at least one segment of lyrics in the lyrics window. In this way, if the user adds the first lyric region in the second region, the terminal device may display the first accompaniment region corresponding to the first lyric region in the second region, reducing the complexity of the music creation. Iin response to the editing operation for the first lyric region, the terminal device may automatically generate lyrics, thereby improving the efficiency of music creation.

Based on any one of the above embodiments, after the first accompaniment region is displayed in the first region and the first lyric region is displayed in the second region, the method of audio processing further includes a method for displaying a first voice input by the user, and the method for displaying the first voice is described in detail below with reference to FIG. 15.

FIG. 15 is a schematic diagram of a method for displaying a first voice according to the embodiments of the present disclosure. In the embodiment shown in FIG. 15, the first region further includes a second audio track. With reference to FIG. 15, the method includes the following steps.

At S1501: in response to a touch operation on the second audio track, display a sound effect window.

Optionally, the sound effect window includes a sound effect control. For example, the sound effect window may include an audio mixing control and an electric music control. Optionally, the second audio track is used to display the voice input by the user. For example, if the user inputs a segment of voice to the terminal device, a second audio track may display a spectrum diagram or a note graph corresponding to the segment of voice. Optionally, in response to a touch operation on the second audio track, the terminal device may display a sound effect window in the first page. For example, if the user clicks the second audio track, the terminal device may display the sound effect window in the first region, the terminal device may display the sound effect window in the second region, and the terminal device may display the sound effect window in other region of the first page, which is not limited in the embodiments of the present disclosure.

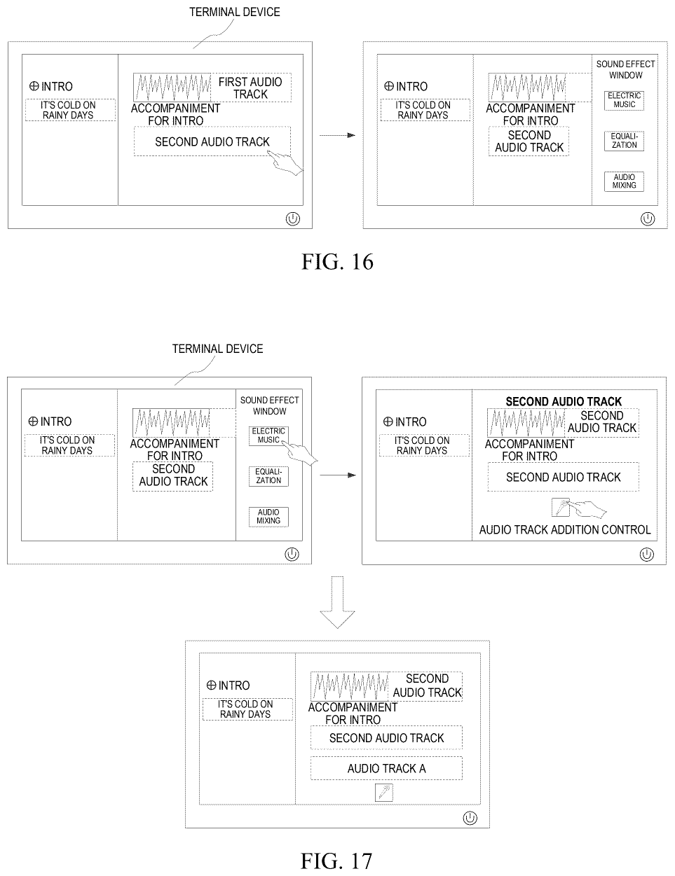

The process of displaying the sound effect window is described below with reference to FIG. 16.

FIG. 16 is a schematic diagram of a process of displaying a sound effect window according to the embodiments of the present disclosure. Referring to FIG. 16, a terminal device is included. The display page of the terminal device includes a first page, and the first page includes a first region and a second region. The second region includes a lyrics paragraph title “intro” and lyrics “it's cold on rainy days”. The first region includes a first audio track and a second audio track, the first audio track includes an accompaniment region of an intro, and the accompaniment region of the intro includes an accompaniment of the intro.

Referring to FIG. 16, if the user clicks on the second audio track, the right side of the first region may pop up the sound effect window. The sound effect window includes an electric music control, an equalization control and an audio mixing control. The electric music control may modify the timbre of the voice input by the user into the timbre of the electric music, the equalization control may modify the timbre of the voice input by the user into an equalized timbre, and the audio mixing control may modify the timbre of the voice input by the user into the timbre of the audio mixing. In this way, the terminal device includes multiple music creation functions, allowing users to personalize and diversify their music creation, improve their experience, and improve the efficiency of music creation.

At S1502: in response to a touch operation on the sound effect control, determine a target sound effect.

Optionally, the sound effect window includes at least one sound effect control. If the user clicks the sound effect control, the terminal device may determine the target sound effect. For example, the sound effect window includes an audio mixing control and an electric music control. If the user clicks the audio mixing control, the target sound effect is audio mixing, and if the user clicks the electric music control, the target sound effect is electric music.

Optionally, after a touch operation on the sound effect control is performed, the terminal device may display an audio track addition control in the first region. In response to a touch operation on the audio track addition control, an audio track associated with the second audio track is displayed in the first region. For example, after the user clicks the sound effect control in the sound effect window, the terminal device may display the audio track addition control in the lower side region of the second audio track. If the user clicks the audio track addition control, the terminal device may display another audio track in the lower side region of the second audio track. The function of the audio track is the same as the function of the second audio track. If the voice input by the user is displayed using the audio track, the sound effect may be re-selected. Optionally, the sound effect that is the same as the second audio track may be used, which is not limited in the embodiments of the present disclosure.

The process of adding the audio track associated with the second audio track will be described below with reference to FIG. 17.

FIG. 17 is a schematic diagram of adding an audio track associated with a second audio track according to the embodiments of the present disclosure. Referring to FIG. 17, a terminal device is included. The display page of the terminal device includes a first page, and the first page includes a first region and a second region. The second region includes a lyrics paragraph title “intro” and lyrics “it's cold on rainy days”. The first region includes a first audio track, a second audio track, and a sound effect window. The first audio track includes an accompaniment region of an intro. The accompaniment region of the intro includes an accompaniment for the intro, and the sound effect window includes an electric music control, an equalization control, and an audio mixing control.

Referring to FIG. 17, if the user clicks the electric music control, the terminal device cancels the display of the sound effect window, and determines that the sound effect of the second audio track is the sound effect of the electric music. The terminal device displays an audio track addition control on the lower side of the second audio track. If the user clicks the audio track addition control, the terminal device may display an audio track A, where the function of the audio track A is the same as the function of the second audio track. In this way, if the user performs music creation, multiple audio tracks with different sound effects can be created, thereby improving the flexibility of music creation.

At S1503: in response to a voice operation input by a user, display a first voice associated with the voice operation on the second audio track.

Optionally, the voice trigger operation may be the voice input by the user. For example, after the first accompaniment region is displayed in the first region and the second region displays the first lyric region, the user may perform singing according to the accompaniment in the first accompaniment region and the lyrics in the first lyric region, the terminal device may obtain the content sung by the user, and display a note graph corresponding to the voice of the user in the second audio track.

Optionally, the sound effect associated with the timbre in the first voice is the target sound effect. For example, if the target sound effect of the second audio track is electric music, the timbre in the music sung by the user is the timbre of electric music, and if the target sound effect of the second audio track is audio mixing, the timbre in the music sung by the user is the timbre of audio mixing. Optionally, the terminal device may display, in the audio track associated with the second audio track, other voice different from the sound effect of the first voice, which may improve flexibility of audio editing.

The embodiments of the present disclosure provide a method of displaying a first voice, and the method includes: displaying a sound effect window in response to a touch operation on a second audio track, determining a target sound effect in response to a touch operation on a sound effect control in the sound effect window, and displaying the first voice associated with the voice trigger operation on the audio track in response to a voice operation for input. In this way, after the terminal device determines accompaniment and lyrics, the terminal device may display the user's singing content in the first region, thereby improving the effect of music creation.

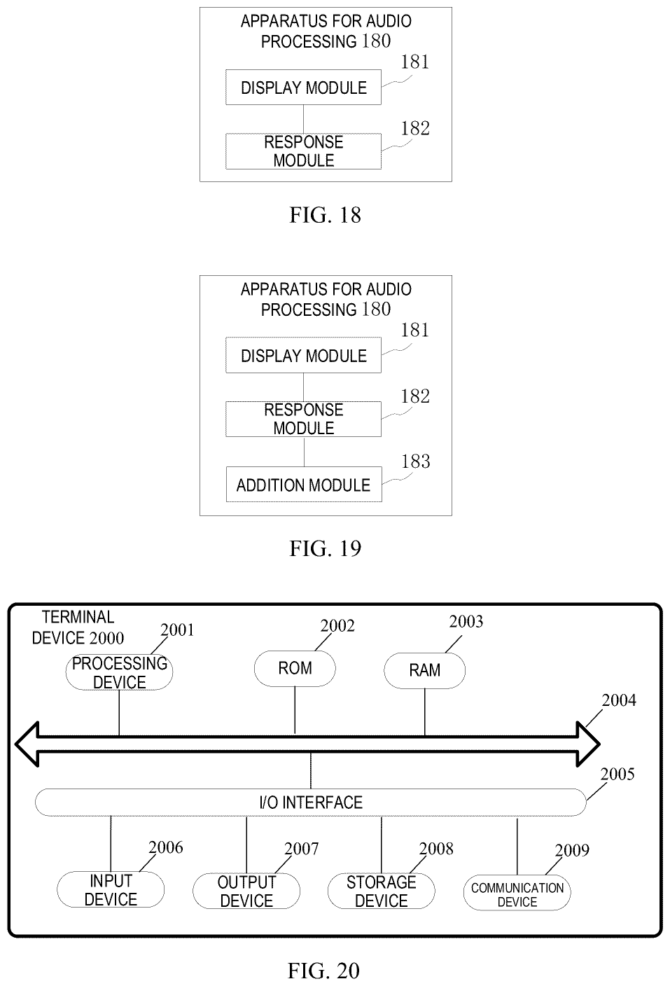

FIG. 18 is a schematic structural diagram of an apparatus for audio processing according to the embodiments of the present disclosure. Referring to FIG. 18, the apparatus for audio processing 180 includes a display module 181 and a response module 182.

The display module 181 is configured to display a first page comprising a first region associated with audio editing and a second region associated with text editing.

The response module 182 is configured to, in response to an editing operation on the first region or the second region, display a first accompaniment region in the first region and display a first lyric region in the second region.

According to one or more embodiments of the present disclosure, the response module 182 is specifically configured to, in response to a trigger operation on the first region, display the first accompaniment region in the first region, and display the first lyric region corresponding to the first accompaniment region in the second region; or, in response to a trigger operation on the second region, display the first lyric region in the second region, and display the first accompaniment region corresponding to the first lyric region in the first region.

According to one or more embodiments of the present disclosure, the response module 182 is specifically configured to, in response to a touch operation on the first audio track, display an accompaniment style window in the first region, wherein the accompaniment style window comprises a plurality of accompaniment style controls; in response to a touch operation on the accompaniment style controls, determine a target accompaniment style; in response to a touch operation on the first audio track, display the first accompaniment region on the first audio track, wherein the first accompaniment region comprises an accompaniment of the target accompaniment style.

According to one or more embodiments of the present disclosure, the response module 182 is specifically configured to, in response to a touch operation on the first audio track, display an accompaniment addition window, wherein the accompaniment addition window comprises an accompaniment paragraph control, and an accompaniment paragraph is a position of a segment of accompaniment in a whole accompaniment; in response to a touch operation on the accompaniment paragraph control, display the first accompaniment region on the first audio track, wherein a paragraph of an accompaniment associated with the first accompaniment region is the same as an accompaniment paragraph corresponding to the accompaniment paragraph control.

According to one or more embodiments of the present disclosure, the first accompaniment region further comprises an accompaniment display region, and the accompaniment display region comprises an amplitude waveform corresponding to an accompaniment associated with the first accompaniment region.

According to one or more embodiments of the present disclosure, the response module 182 is specifically configured to, in response to a touch operation on the accompaniment display region, adjust a size of the accompaniment display region and adjust the amplitude waveform.

According to one or more embodiments of the present disclosure, the response module 182 is specifically configured to, in response to a touch operation on the second region, display a lyric paragraph window in the second region, wherein the lyric paragraph window comprises a lyric paragraph control; in response to a touch operation on the lyric paragraph control, display the first lyric region in the second region, wherein the first lyric region comprises a lyric paragraph title associated with the lyric paragraph control.

According to one or more embodiments of the present disclosure, the response module 182 is specifically configured to, in response to an editing operation on the target region in the first lyric region, display a lyric window, wherein the lyric window comprises at least one segment of lyric associated with the editing operation; in response to a touch operation on a target lyric in the at least one segment of lyric, display the target lyric in the target region.

According to one or more embodiments of the present disclosure, the response module 182 is specifically configured to, in response to a deletion operation on the first accompaniment region, cancel the display of the first lyric region associated with the first accompaniment region in the second region; or in response to a deletion operation on the first lyric region, cancel the display of the first accompaniment region corresponding to the first lyric region in the first region.

According to one or more embodiments of the present disclosure, the response module 182 is specifically configured to, in response to a touch operation on the second audio track, display a sound effect window comprising a sound effect control; in response to a touch operation on the sound effect control, determine a target sound effect; in response to a voice operation input by a user, display, on the second audio track, a first voice associated with the voice operation, wherein a sound effect associated with a timbre in the first voice is the target sound effect.

The apparatus for audio processing provided in the embodiments of the present disclosure may be configured to perform the technical solutions in the foregoing method embodiments, and implementation principles and technical effects thereof are similar, and details are not described here again in this embodiment.

FIG. 19 is a schematic structural diagram of another apparatus for audio processing according to the embodiments of the present disclosure. Referring to FIG. 19, the apparatus for audio processing 180 further includes an addition module 183. The addition module 183 is configured to display an audio track addition control in the first region; in response to a touch operation on the audio track addition control, display an audio track associated with the second audio track in the first region.

The apparatus for audio processing provided in the embodiments of the present disclosure may be configured to perform the technical solutions in the foregoing method embodiments, and implementation principles and technical effects thereof are similar, and details are not described here again in this embodiment.

The embodiments of the present disclosure further provide a computer readable storage medium storing computer executable instruction which, when the processor executes the computer executable instructions, enable the processor to perform the method according to the foregoing method embodiments.

The embodiments of the present disclosure further provide a computer program, when executed by a processor, implementing the method according to the foregoing method embodiments.

The embodiments of the present disclosure further provide a computer program product, including a computer program which, when executed by a processor, implements the method according to the foregoing method embodiments.

The present disclosure provides a method, apparatus and terminal device for audio processing. The terminal device can display a first page comprising a first region associated with audio editing and a second region associated with text editing, in response to an editing operation on the first region or the second region, display a first accompaniment region in the first region and display a first lyric region in the second region. In the foregoing method, if the user edits the first region, the terminal device may display the first accompaniment region in the first region, and display the first lyric region associated with the first accompaniment region in the second region. If the user performs the editing operation on the second region, the terminal device may display the first lyric region in the second region, and display the first accompaniment region corresponding to the first lyric region in the first region. Therefore, the user performs the editing operation in any region, and the terminal device may display the associated content in another region, thereby reducing the operation complexity during music creation, thereby reducing the complexity of music creation and improving the efficiency of music creation.

FIG. 20 is a schematic structural diagram of a terminal device according to the embodiments of the present disclosure. FIG. 20 is a schematic structural diagram of a terminal device 2000 suitable for implementing embodiments of the present disclosure, and the terminal device 2000 may be a terminal device or a server. The terminal device may include, but is not limited to, a mobile terminal such as a mobile phone, a laptop, a digital broadcast receiver, a personal digital assistant (PDA), a tablet (PAD), a portable multimedia player (PMP), an in-vehicle terminal (for example, a car navigation terminal), and a fixed terminal such as a digital TV, a desktop computer, or the like. The terminal device shown in FIG. 20 is merely an example and should not impose any limitation on the functionality and use ranges of the embodiments of the present disclosure.

As shown in FIG. 20, the terminal device 2000 may include a processing device (for example, a central processing unit or a graphics processor) 2001, and may perform various appropriate actions and processing according to a program stored in a read-only memory (ROM) 2002 or a program loaded into a random access memory (RAM) 2003 from a storage device 2008. In the RAM 2003, various programs and data required by the operation of the terminal device 2000 are also stored. The processing device 2001, the ROM 2002, and the RAM 2003 are connected to each other through a bus 2004. An input/output (I/O) interface 2005 is also connected to the bus 2004.

Generally, the following devices may be connected to the I/O interface 2005: an input device 2006 including, for example, a touch screen, a touch pad, a keyboard, a mouse, a camera, a microphone, an accelerometer, a gyroscope, etc.; an output device 2007 including, for example, a liquid crystal display (LCD), a speaker, a vibrator, etc.; a storage device 2008 including, for example, a magnetic tape, a hard disk, etc.; and a communication device 2009. The communication device 2009 may allow the terminal device 2000 to communicate wirelessly or wired with other devices to exchange data. Although FIG. 20 illustrates a terminal device 2000 having various devices, it should be understood that all illustrated devices are not required to be implemented or provided. More or fewer devices may alternatively be implemented or provided.

In particular, according to the embodiments of the present disclosure, the process described above with reference to the flowchart may be implemented as a computer software program. For example, embodiments of the present disclosure include a computer program product comprising a computer program embodied on a computer readable medium, the computer program comprising program code for performing the method shown in the flowchart. In such embodiments, the computer program may be downloaded and installed from the network through the communication device 2009, or installed from the storage device 2008, or from the ROM 2002. When the computer program is executed by the processing device 2001, the foregoing functions defined in the method of the embodiments of the present disclosure are performed.

It should be noted that the computer readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), and the like, or any suitable combination thereof.

The computer readable medium may be included in the foregoing terminal device, or may exist separately, and is not assembled into the terminal device.

The computer readable medium carries one or more programs, and when the one or more programs are executed by the terminal device, the terminal device performs the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. In some cases, the name of a unit does not constitute a limitation on the unit itself. For example, a first obtaining unit may be further described as “obtaining at least two units of Internet Protocol addresses”.

The functions described above may be performed, at least in part, by one or more hardware logic components. For example, without limitation, the example types of hardware logic components that may be used include: a field programmable gate array (FPGA), an application specific integrated circuit (ASIC for short), an application specific standard product (ASSP), a system on chip (SoC for short), a complex programmable logic device (Complex Programmable Logic Device, CPLD for short), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

It should be noted that the modification of “a” and “a plurality” mentioned in this disclosure is illustrative and not limiting, and those skilled in the art should understand that “one or more” should be understood unless the context clearly indicates otherwise.

The names of messages or information exchanged between multiple devices in embodiments of the present disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as terminal devices, applications, servers, or storage media that perform the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the terminal device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations. The data may include information, parameters, messages, and the like, such as flow cut indication information.

The above description is only the preferred embodiments of this disclosure, and an explanation of the technical principles used. Those skilled in the art should understand that the scope of disclosure referred to in this disclosure is not limited to technical solutions formed by specific combinations of the aforementioned technical features, but also covers other technical solutions formed by arbitrary combinations of the aforementioned technical features or their equivalent features without departing from the aforementioned disclosed concept. For example, a technical solution formed by replacing the above features with (but not limited to) technical features with similar functions disclosed in this disclosure.

Furthermore, although each operation is depicted in a specific order, this should not be understood as requiring them to be executed in the specific order shown or in a sequential order. In certain environments, multitasking and parallel processing may be advantageous. Similarly, although several specific implementation details are included in the above discussion, these should not be interpreted as limiting the scope of this disclosure. Some features described in the context of individual embodiments can also be combined and implemented in a single embodiment. On the contrary, various features described in the context of a single embodiment can also be implemented individually or in any suitable sub combination in multiple embodiments.

Although the subject matter has been described in language specific to structural features and/or method logical actions, it should be understood that the subject matter limited in the attached claims may not necessarily be limited to the specific features or actions described above. On the contrary, the specific features and actions described above are only exemplary forms of implementing the claims.

1. A method of audio processing, comprising:
displaying a first page comprising a first region associated with audio editing and a second region associated with text editing; and
in response to an editing operation on the first region or the second region, displaying a first accompaniment region in the first region, and displaying a first lyric region in the second region.

2. The method of claim 1, wherein displaying the first accompaniment region in the first region and displaying the first lyric region in the second region in response to the editing operation on the first region or the second region comprises:
in response to a trigger operation on the first region, displaying the first accompaniment region in the first region, and displaying the first lyric region corresponding to the first accompaniment region in the second region; or
in response to a trigger operation on the second region, displaying the first lyric region in the second region, and displaying the first accompaniment region corresponding to the first lyric region in the first region.

3. The method of claim 2, wherein the first region comprises a first audio track, and displaying the first accompaniment region in the first region in response to the trigger operation on the first region comprises:
in response to a touch operation on the first audio track, displaying an accompaniment style window in the first region, wherein the accompaniment style window comprises a plurality of accompaniment style controls;
in response to a touch operation on the accompaniment style controls, determining a target accompaniment style; and
in response to a touch operation on the first audio track, displaying the first accompaniment region on the first audio track, wherein the first accompaniment region comprises an accompaniment of the target accompaniment style.

4. The method of claim 3, wherein displaying the first accompaniment region on the first audio track in response to the touch operation on the first audio track comprises:
in response to a touch operation on the first audio track, displaying an accompaniment addition window, wherein the accompaniment addition window comprises an accompaniment paragraph control, and an accompaniment paragraph is a position of a segment of accompaniment in a whole accompaniment; and
in response to a touch operation on the accompaniment paragraph control, displaying the first accompaniment region on the first audio track, wherein a paragraph of an accompaniment associated with the first accompaniment region is the same as an accompaniment paragraph corresponding to the accompaniment paragraph control.

5. The method of claim 3, wherein the first accompaniment region further comprises an accompaniment display region, and the accompaniment display region comprises an amplitude waveform corresponding to an accompaniment associated with the first accompaniment region.

6. The method of claim 5, further comprising:
in response to a touch operation on the accompaniment display region, adjusting a size of the accompaniment display region and adjusting the amplitude waveform.

7. The method of claim 2, wherein displaying the first lyric region in the second region in response to the trigger operation on the second region comprises:
in response to a touch operation on the second region, displaying a lyric paragraph window in the second region, wherein the lyric paragraph window comprises a lyric paragraph control; and
in response to a touch operation on the lyric paragraph control, displaying the first lyric region in the second region, wherein the first lyric region comprises a lyric paragraph title associated with the lyric paragraph control.

8. The method of claim 7, wherein the first lyric region further comprises a target region associated with the lyric paragraph title; after displaying the first lyric region in the second region, the method further comprises:
in response to an editing operation on the target region in the first lyric region, displaying a lyric window, wherein the lyric window comprises at least one segment of lyric associated with the editing operation; and
in response to a touch operation on a target lyric in the at least one segment of lyric, displaying the target lyric in the target region.

9. The method of claim 1, wherein after displaying the first accompaniment region in the first region and displaying the first lyric region in the second region, the method further comprises:
in response to a deletion operation on the first accompaniment region, cancelling the display of the first lyric region associated with the first accompaniment region in the second region; or
in response to a deletion operation on the first lyric region, cancelling the display of the first accompaniment region corresponding to the first lyric region in the first region.

10. The method of claim 1, wherein the first region comprises a second audio track; after displaying the first accompaniment region in the first region and displaying the first lyric region in the second region, the method further comprises:
in response to a touch operation on the second audio track, displaying a sound effect window comprising a sound effect control;
in response to a touch operation on the sound effect control, determining a target sound effect; and
in response to a voice operation input by a user, displaying, on the second audio track, a first voice associated with the voice operation, wherein a sound effect associated with a timbre in the first voice is the target sound effect.

11. The method of claim 10, wherein after responding to the touch operation on the sound effect control, the method further comprises:
displaying an audio track addition control in the first region; and
in response to a touch operation on the audio track addition control, displaying an audio track associated with the second audio track in the first region.

12. (canceled)

13. A terminal device comprising a processor and a memory, wherein
the memory stores computer execution instructions;
the processor executes the computer execution instructions stored in the memory, so that the processor performs acts of audio processing, the acts comprises:
displaying a first page comprising a first region associated with audio editing and a second region associated with text editing; and
in response to an editing operation on the first region or the second region, displaying a first accompaniment region in the first region, and displaying a first lyric region in the second region.

14. A non-transitory computer readable storage medium storing computer execution instructions which, when a processor executes the computer execution instructions, implements acts of audio processing, the acts comprises:
displaying a first page comprising a first region associated with audio editing and a second region associated with text editing; and
in response to an editing operation on the first region or the second region, displaying a first accompaniment region in the first region, and displaying a first lyric region in the second region.

15. (canceled)

16. (canceled)

17. The device of claim 13, wherein displaying the first accompaniment region in the first region and displaying the first lyric region in the second region in response to the editing operation on the first region or the second region comprises:
in response to a trigger operation on the first region, displaying the first accompaniment region in the first region, and displaying the first lyric region corresponding to the first accompaniment region in the second region; or
in response to a trigger operation on the second region, displaying the first lyric region in the second region, and displaying the first accompaniment region corresponding to the first lyric region in the first region.

18. The device of claim 17, wherein the first region comprises a first audio track, and displaying the first accompaniment region in the first region in response to the trigger operation on the first region comprises:
in response to a touch operation on the first audio track, displaying an accompaniment style window in the first region, wherein the accompaniment style window comprises a plurality of accompaniment style controls;
in response to a touch operation on the accompaniment style controls, determining a target accompaniment style; and
in response to a touch operation on the first audio track, displaying the first accompaniment region on the first audio track, wherein the first accompaniment region comprises an accompaniment of the target accompaniment style.

19. The device of claim 18, wherein displaying the first accompaniment region on the first audio track in response to the touch operation on the first audio track comprises:
in response to a touch operation on the first audio track, displaying an accompaniment addition window, wherein the accompaniment addition window comprises an accompaniment paragraph control, and an accompaniment paragraph is a position of a segment of accompaniment in a whole accompaniment; and
in response to a touch operation on the accompaniment paragraph control, displaying the first accompaniment region on the first audio track, wherein a paragraph of an accompaniment associated with the first accompaniment region is the same as an accompaniment paragraph corresponding to the accompaniment paragraph control.

20. The device of claim 18, wherein the first accompaniment region further comprises an accompaniment display region, and the accompaniment display region comprises an amplitude waveform corresponding to an accompaniment associated with the first accompaniment region.

21. The device of claim 20, further comprising:
in response to a touch operation on the accompaniment display region, adjusting a size of the accompaniment display region and adjusting the amplitude waveform.

22. The device of claim 17, wherein displaying the first lyric region in the second region
in response to the trigger operation on the second region comprises:
in response to a touch operation on the second region, displaying a lyric paragraph window in the second region, wherein the lyric paragraph window comprises a lyric paragraph control; and
in response to a touch operation on the lyric paragraph control, displaying the first lyric region in the second region, wherein the first lyric region comprises a lyric paragraph title associated with the lyric paragraph control. according to any of claims 1 to 11.

23. The device of claim 22 wherein the first lyric region further comprises a target region associated with the lyric paragraph title; after displaying the first lyric region in the second region, the acts further comprises:
in response to an editing operation on the target region in the first lyric region, displaying a lyric window, wherein the lyric window comprises at least one segment of lyric associated with the editing operation; and
in response to a touch operation on a target lyric in the at least one segment of lyric, displaying the target lyric in the target region.
